(19) United States
(12) Patent Application Publication
(10) Pub. No.: US 2020/0215987 A1
(43) Pub. Date: Jul. 9, 2020

(54) Quick Mounting System for Rifles

(71) Applicant: Bryan A. Baker, Dallas, TX (US)

(72) Inventor: Bryan A. Baker, Dallas, TX (US)

(21) Appl. No.: 16/240,657

(22) Filed: Jan. 4, 2019

(51) Int. Cl. B60R 7/14; F41G 11/00; F41C 33/00

(52) U.S. Cl. CPC B60R 7/14; F41C 33/007; F41G 11/003

(57) ABSTRACT

A quick mounting system for securing a long gun to a carrier comprises a quick-release clamp having first and second opposingly disposed jaw components, a biasing member urging the first and second jaw components apart, and a lever coupled to the first jaw component and configured to urge the first jaw component toward the second jaw component while in a first position and to allow the first jaw component to be urged apart from the second jaw component by the biasing member while in a second position. The first and second jaw components are contoured to firmly and securely grasp an accessory rail mounted on the long gun by operations of the lever.

### FIELD

The present disclosure relates to a firearm accessory, and particularly to a quick mounting system for rifles.

### BACKGROUND

The Picatinny Rail, also known as a pic rail, MIL-STD-1913 rail, or STANAG 2324 rail, is a military standard interface system incorporated or attached to long guns for mounting firearm accessories. It was originally used for attaching scopes to the firearm, and later use of the picatinny rail expanded to attaching other types of accessories, such as sights, lights, lasers, to the firearm. FIG. 13 shows a typical Picatinny handguard for a large caliber firearm.

As shown in FIGS. 14 and 15, the Picatinny rail is a strip undercut to form a “flattened T” or hexagonal cross-section provided with crosswise slots at regular intervals. A newer standard, the NATO Rail, has a profile that is slightly modified from the Picatinny Rail. An older system, called the Weaver Rail, has a rectangular profile instead of the hexagonal shape.

### BRIEF DESCRIPTION OF THE DRAWINGS

FIG. 1 is an illustration of the application of a quick mounting system for rifles on a utility task vehicle (UTV) roll cage according to the teachings of the present disclosure;

FIG. 2 is a cross-sectional view of an exemplary embodiment of a quick mounting system for rifles for mounting on a utility task vehicle (UTV) roll cage according to the teachings of the present disclosure;

FIG. 3 is an illustration of the application of a quick mounting system for rifles on an all-terrain vehicle (ATV) cargo rack according to the teachings of the present disclosure;

FIG. 4 is a cross-sectional view of an exemplary embodiment of a quick mounting system for rifles for mounting on an all-terrain vehicle (ATV) cargo rack according to the teachings of the present disclosure;

FIG. 5 is a cross-sectional view of an exemplary embodiment of a quick mounting system for rifles for mounting on an elongated stud according to the teachings of the present disclosure;

FIG. 6 is a top view of an exemplary embodiment of a quick-release clamp of the quick mounting system for rifles according to the teachings of the present disclosure;

FIGS. 7 and 8 are side views of an exemplary embodiment of a quick-release clamp of the quick mounting system for rifles according to the teachings of the present disclosure;

FIG. 9 is a bottom view of an exemplary embodiment of a quick-release clamp of the quick mounting system for rifles according to the teachings of the present disclosure;

FIG. 10 is an end view of an exemplary embodiment of a quick mounting system for rifles according to the teachings of the present disclosure;

FIG. 11 illustrates components of an exemplary embodiment of a quick mounting system for rifles according to the teachings of the present disclosure;

FIG. 12 illustrates components of an ATV mount for an exemplary embodiment of a quick mounting system for rifles according to the teachings of the present disclosure;

FIG. 13 is a perspective view of a typical Picatinny rail handguard; and

FIGS. 14 and 15 are diagrams illustrating the dimensions of the Picatinny rail mounting system standard.

### DETAILED DESCRIPTION

It is recognized that firearm such as rifles, shotguns, and large caliber weapons with long barrels should be stored, carried, and transported in a secure manner to avoid inadvertent or accidental misfire. It is also desirable that the firearm remains quickly and easily accessible. The quick mounting system described herein provides a solution that addresses these requirements.

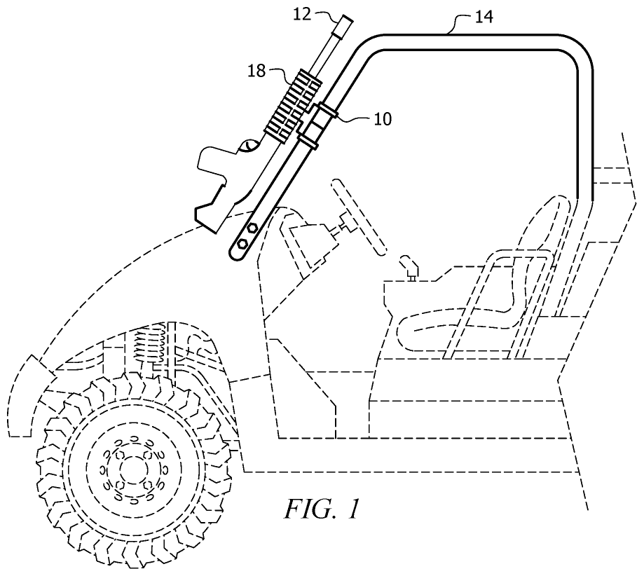

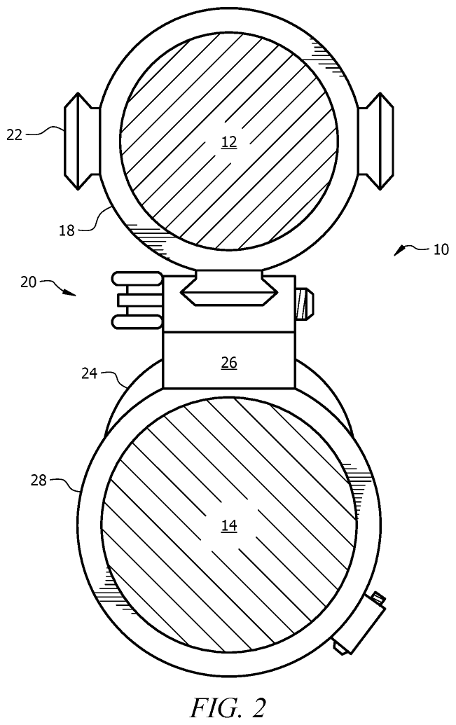

FIG. 1 is an illustration of the application of a quick mounting system 10 for a long firearm 12 that can be mounted on anywhere, such as on the column of a utility task vehicle (UTV) roll cage 14 according to the teachings of the present disclosure. As shown in more detail in FIG. 2, a cross-sectional view of an exemplary embodiment of a quick mounting system 10 for mounting on a carrier such as a UTV roll cage 14 includes a quick-release clamp 20 that is configured to fasten around the Picatinny rail 22 of the Picatinny handguard 18 mounted on a long gun 12. The quick mounting system 10 may be secured to the UTV roll cage 14 using one or more pipe clamps 24 threaded through a base 26. A strip of isolation material 28 may be used to provide some padded separation between the base 26 and the metal post 14 of the roll cage. This isolation helps to reduce or eliminate noise generated by the metal-on-metal vibration between the base 26 and the roll cage 14 when the vehicle is moving.

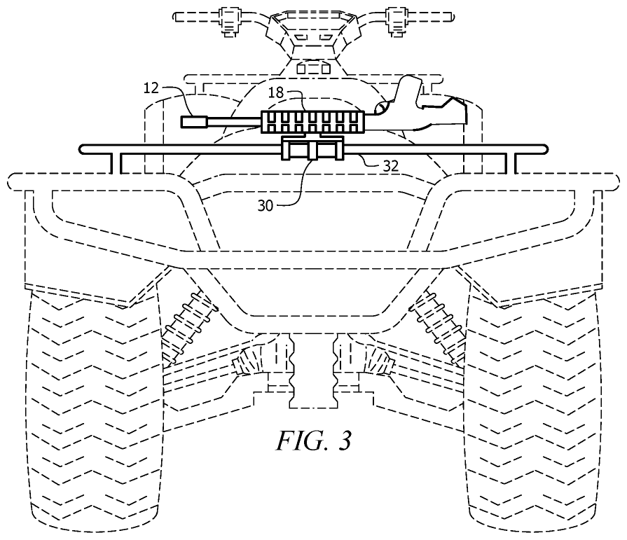

FIG. 3 is an illustration of using the quick mounting system 10 on an all-terrain vehicle (ATV) cargo rack 16. As shown in more detail in FIG. 4, a cross-sectional view of an exemplary embodiment of a quick mounting system 30 for mounting on an all-terrain vehicle cargo rack 32 includes a quick-release clamp 20 and base 26 that is configured to fasten around the Picatinny rail 22 of the Picatinny handguard 18 mounted on a long gun 12. The quick mounting system 30 may be secured to a carrier such as an ATV cargo rack 32 by attaching the base 26 of the clamp 20 to a mounting bracket 37. The mounting bracket 37 preferably includes two components 38 and 39 that clamp around the rail of the cargo rack 32.

FIG. 5 is a cross-sectional view of an exemplary embodiment of a quick mounting system 46 for rifles for mounting on an elongated stud according to the teachings of the present disclosure. The quick mounting system 40 includes a quick-release clamp 20 that is configured to fasten around the Picatinny rail 22 of the Picatinny handguard 18 mounted on a long gun 12. The quick mounting system 40 includes a base 26 that is secured to an elongated stud 44 that can be inserted into an opening or indentation defined in a surface, object, or fixture. This quick mounting system may be used for organized storage of firearms. For example, a gun safe may employ the quick mounting system to firmly secure long guns stored therein in an orderly manner. The elongated stud 44 can be fabricated from metal, wood, plastic, and other suitable materials.

By utilizing the standard dimensions of the rail system of a Picatinny handguard 18, a long gun such as a rifle and shotgun can be quickly fastened to any component or fixture that is configured to accept the quick mounting systems described herein and be transported or stored in a safe and secure manner.

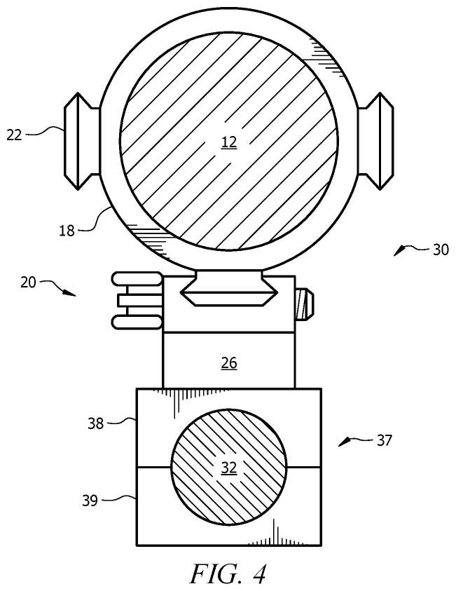

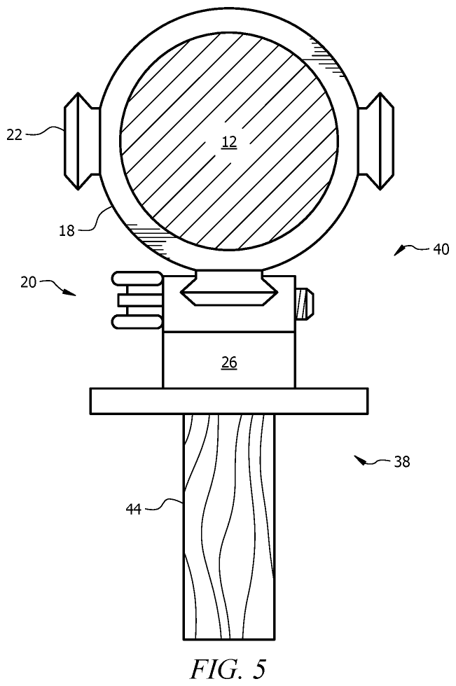

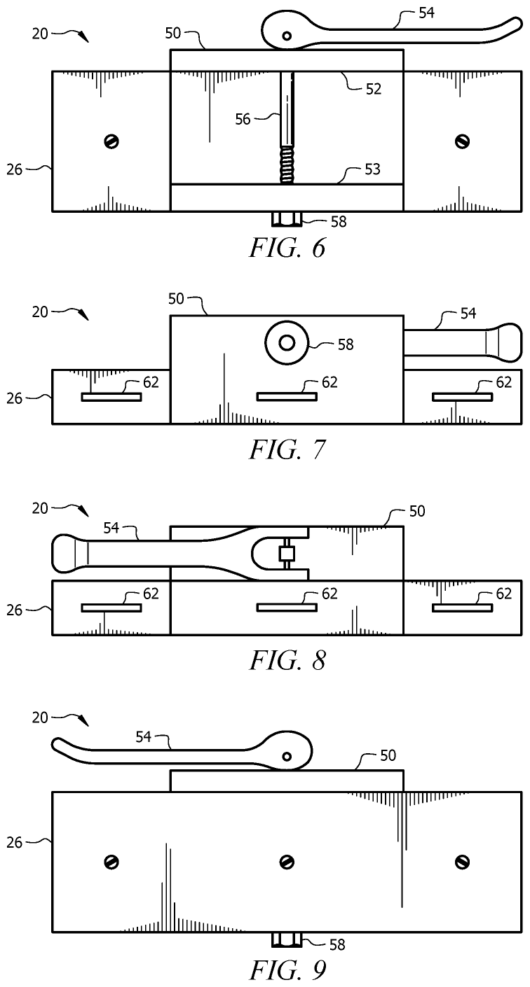

Referring to FIGS. 6-10 for the top, side, bottom, and end views of an exemplary embodiment of a quick-release clamp 20 of the quick mounting system for long guns according to the teachings of the present disclosure. The quick-release clamp 20 includes a spring-loaded vise 50 with two parallel jaws 52 and 53 that can be brought closer together by the operations of a lever 54. The width of the opening between parallel jaws 52 and 53 can be adjusted with the threaded rod 56 and nut 58 to accommodate rail interfaces with different dimensions. Two biasing members or helical springs 60 are installed the jaws 52 and 53 apart unless the lever 54 is flipped to bring the jaws closer together. Three slots 62 are defined in below the vise jaws 52 and 53 to allow pipe clamps or other similar fasteners to be threaded therethrough. Further, the base 26 may define openings to accept screws that can attach the quick-release clamp 20 to a carrier, such as a vehicle, a wall, a fixture, or an object. It should be noted that the base 26 for the quick mounting system 30 and 40 do not require the slots 26 designed to accept the pipe clamps used to secure it to a carrier such as the UTV roll over cage.

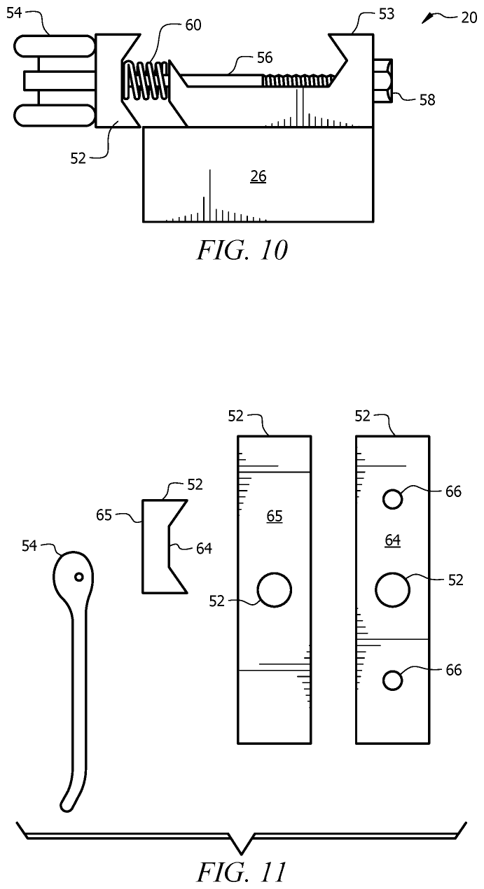

FIG. 11 are end view and side views 64 and 65 of one of the vise jaw component 52 of the quick-release clamp 20. The jaw component 52 has an opening that allows the threaded rod 56 to pass through and connect it to the other jaw component 53. Further, side 64 of the jaw component 52 that faces jaw component 53, when assembled, also includes indentations 66, on either side of the threaded rod opening 52, that serve to retain the springs 60. As can be seen in FIG. 10, the springs 60 is biased against the jaw component 52 to be spaced from the other jaw component 53. When the lever 54 is flipped, the shape or contour of the lever causes the jaw 52 to be urged against the springs 60 and the jaw 53 so that a Picatinny rail placed between the jaws would be firmly grasped between them.

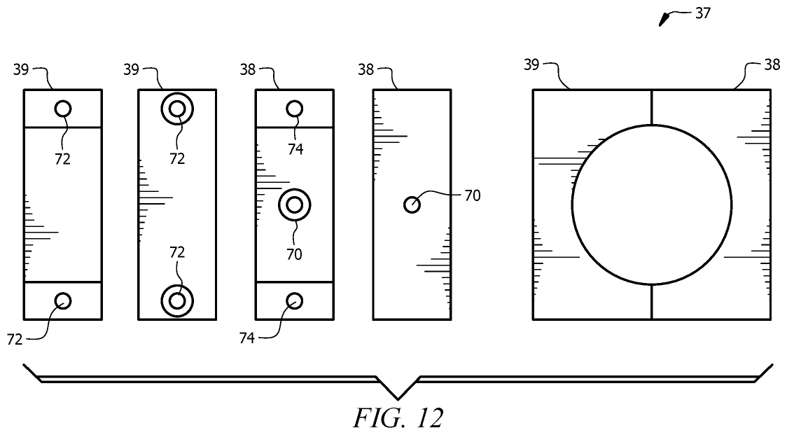

FIG. 12 illustrates components of an ATV mount 37 for an exemplary embodiment of a quick mounting system for rifles according to the teachings of the present disclosure. As described above with reference to FIG. 4, the quick mounting system 30 for mounting on a all-terrain vehicle cargo rack 32 includes a quick-release clamp 20 and base 26 that is configured to fasten around the Picatinny rail mounted on a long gun. The quick mounting system 30 may be secured to the ATV cargo rack 32 by attaching the base 26 of the clamp 20 to a mounting bracket 37 with two components 38 and 39 that define a circular void that fits around a cargo rack bar. The bracket component 38 may be secured to the base 26 of the clamp 20 via a bolt inserted through a central opening 70 and fastened with a nut. FIG. 12 shows two sides of the bracket component 38. The bottom component 39 of the mounting bracket 37 is configured to clamp around a cylindrical bar of the ATV cargo rack and be fastened to the other component 38 using two threaded bolts inserted through two openings 72 in the bottom bracket component 39. Threaded indentations 74 are formed in the top bracket component 38 to accept the bolts.

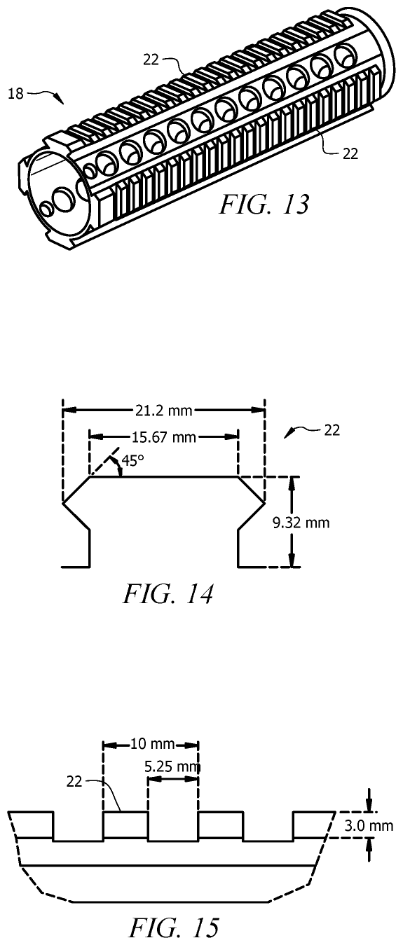

FIG. 13 is a perspective view of a typical Picatinny rail handguard 18 that is configured for mounting on the long barrel of a firearm. FIGS. 14 and 15 are diagrams illustrating the dimensions of the Picatinny rail mounting system standard. The Picatinny rail is a strip undercut to form a “flattened T” or hexagonal cross-section having a smaller width of 15.67 mm and a larger width of 21.2 mm. The crosswise slots occur at regular intervals having a width of 0.206 in (5.23 mm), the spacing of slot centers at 0.394 in (10.01 mm), and the slot depth at 0.118 in (3.00 mm).

Heretofore the weapon accessory rail systems have been used to fasten accessories to the rifle, where the rifle is “carrying” and supporting the accessories. The new use of the accessory rail system described herein enables these weapons to be securely attached to a vehicle for transportation purposes, or to another surface/object for storage purposes. The term “carrier” is used herein to mean any underlying fixture, surface, vehicle, device, etc. that serves to “carry” and support the long gun as enabled by the quick mounting system. Components of the quick mounting system can be fabricated from metal, wood, plastic, other suitable materials, and combinations thereof.

The quick mounting system described herein can be used with the NATO Accessory Rail (STANAG 4649), the Weaver Rail, and other accessory mounting interface systems now known and to be developed, with or without some adjustment or adaptation.

The features of the present invention which are believed to be novel are set forth below with particularity in the appended claims. However, modifications, variations, and changes to the exemplary embodiments described above will be apparent to those skilled in the art, and the quick mounting system for rifles described herein thus encompasses such modifications, variations, and changes and are not limited to the specific embodiments described herein.

What is claimed is:

1. A quick mounting system for securing a long gun to a carrier, comprising:
a quick-release clamp having first and second opposingly disposed jaw components;
a biasing member urging the first and second jaw components apart;
a lever coupled to the first jaw component and configured to urge the first jaw component toward the second jaw component while in a first position and to allow the first jaw component to be urged apart from the second jaw component by the biasing member while in a second position; and
wherein the first and second jaw components are contoured to firmly and securely grasp an accessory rail mounted on the long gun by operating the lever.

2. The system of claim 1, wherein the first and second jaw components are contoured to firmly and securely grasp an accessory rail selected from the group consisting of a Picatinny rail, a NATO rail, and a Weaver rail.

3. The system of claim 1, further comprising a mounting bracket coupled to the quick-release clamp configured to fasten the quick-release clamp to the carrier.

4. The system of claim 1, further comprising an elongated stud coupled to the quick-release clamp configured to fasten the quick-release clamp to the carrier.

5. The system of claim 1, further comprising a fastener configured to fasten the quick-release clamp to the carrier.

6. The system of claim 1, further comprising a vibration isolation material separating the quick-release clamp and the carrier.

7. The system of claim 1, further comprising a base defining a plurality of slots configured to receive a plurality of pipe clamps to fasten the quick-release clamp to the carrier.

8. The system of claim 1, further comprising a threaded rod connecting and aligning first and second jaw components with one another.

9. A quick mounting system for securing a long gun to a vehicle, comprising:
a quick-release clamp having first and second opposingly disposed parallel jaw components;
at least one spring urging the first and second jaw components apart;
a lever coupled to the first jaw component and configured to displace the first jaw component toward the second jaw component while in a first position and to allow the first jaw component to be urged apart from the second jaw component by the at least one spring while in a second position; and
wherein the first and second jaw components are contoured to firmly and securely grasp a Picatinny rail mounted on the long gun by operating the lever.

10. The system of claim 9, further comprising a mounting bracket coupled to the quick-release clamp configured to fasten the quick-release clamp to a cargo rack of the vehicle.

11. The system of claim 9, further comprising an elongated stud coupled to the quick-release clamp configured to fasten the quick-release clamp to the vehicle.

12. The system of claim 9, further comprising at least one pipe clamp configured to fasten the quick-release clamp to a vehicle frame of the vehicle.

13. The system of claim 12, further comprising a vibration isolation material separating the quick-release clamp and the vehicle frame of the vehicle.

14. The system of claim 9, further comprising a base defining a plurality of slots configured to receive a plurality of pipe clamps to fasten the quick-release clamp to the vehicle.

15. The system of claim 9, further comprising a threaded rod connecting and aligning first and second jaw components with one another.

16. A quick mounting system for securing a long gun to a carrier, comprising:
a spring-loaded quick-release clamp configured to firmly and securely grasp an accessory rail attached to the long gun; and
a lever coupled to the spring-loaded quick-release clamp and configured to close the clamp around the accessory rail while the lever is in a first position and to open the clamp releasing the accessory rail while the lever is in a second position.

17. The system of claim 16, further comprising a mounting bracket coupled to the quick-release clamp configured to fasten the quick-release clamp to a cargo rack of a vehicle.

18. The system of claim 16, further comprising an elongated stud coupled to the quick-release clamp configured to fasten the quick-release clamp to a vehicle.

19. The system of claim 16, further comprising at least one pipe clamp configured to fasten the quick-release clamp to a vehicle frame of a vehicle.

20. The system of claim 19, further comprising a vibration isolation material separating the quick-release clamp and the vehicle frame of the vehicle.
